(19) United States
(12) Patent Application Publication
(10) Pub. No.: US 2026/0015037 A1
(43) Pub. Date: Jan. 15, 2026

(54) STEERING DEVICE

(71) Applicant: HYUNDAI MOBIS CO., LTD., Seoul (KR)

(72) Inventors: Min Gu KIM, Yongin-si (KR); Dong Hyun KIM, Yongin-si (KR); Kwang Yoon KIM, Yongin-si (KR)

(73) Assignee: HYUNDAI MOBIS CO., LTD., Seoul (KR)

(21) Appl. No.: 19/090,812

(22) Filed: Mar. 26, 2025

(30) Foreign Application Priority Data
Jul. 11, 2024 (KR) 10-2024-0091657

(51) Int. Cl. B62D 7/15

(52) U.S. Cl. CPC B62D 7/159

(57) ABSTRACT

A steering device includes a steering shaft that moves in a longitudinal direction in conjunction with rotation of a steering wheel, a magnet attached to the steering shaft, a control module disposed adjacent to the steering shaft, and a sensing unit disposed on a surface of the control module to detect a magnetic field. The control module detects a rotation angle of a wheel linked to the steering wheel through the magnetic field detected by the sensing unit.

### CROSS REFERENCE TO RELATED APPLICATION

This application claims priority to and the benefit of Korean Patent Application No. 10-2024-0091657, filed on Jul. 11, 2024, the disclosure of which is incorporated herein by reference in its entirety.

### BACKGROUND

### Field of the Invention

The present invention relates to a steering device, and more specifically, to a steering device having a sensor capable of easily detecting a rotation angle of a vehicle wheel.

### Description of Related Art

In general, a rear wheel steering (RWS) system for a vehicle, in which a hydraulic device, a motor, and a reducer are mounted, serves to steer rear wheels of a vehicle according to a driving situation of the vehicle.

An RWS system is generally operated for the purpose of reducing a rotation radius of a wheel when the vehicle travels at a low speed and improving driving stability when the vehicle travels at a high speed. That is, when the vehicle travels at a low speed, the RWS system controls a rear wheel steering angle in a direction opposite to that of a front wheel steering angle, and when the vehicle travels at a high speed, the RWS system controls the rear wheel steering angle in the same direction (i.e., in the same phase) as the front wheel steering angle.

Therefore, the conventional vehicle or integrated RWS system can control a rear wheel tow angle in the same direction as that of a front wheel tire when the vehicle turns at a high speed, thereby greatly improving the stability of the vehicle.

A system for adjusting a rear wheel steering angle according to a front wheel steering angle can be automated. That is, the system can detect the front wheel steering angle using a steering device provided with a separate sensor and adjust the rear wheel steering angle in response thereto.

The conventional steering device can detect the front wheel steering angle by applying a sensor for detecting a magnetic force of a magnet provided on a shaft. In order for a motor and a sensor provided adjacent to the shaft, the sensor is attached to one side of the shaft, and a separate cable connecting the sensor to the motor is provided so that the motor and the sensor are electrically connected and also the sensor is disposed adjacent to the magnet.

However, to expand a market, it is necessary to simplify a structure and improve performance to reduce costs.

### SUMMARY

One embodiment of the present invention is directed to providing a steering device capable of easily detecting a rotation amount of a wheel without a separate cable.

Objects of the present invention are not limited to the above-described object, and other objects that are not described will be able to be clearly understood by those skilled in the art from the following description.

According to an aspect of the present invention, there is provided a steering device including a steering shaft configured to move in a longitudinal direction in conjunction with rotation of a steering wheel; a magnet attached to the steering shaft; a control module disposed adjacent to the steering shaft; and a sensing unit disposed on a surface of the control module and configured to detect a magnetic field. The control module is configured to detect a rotation angle of a wheel linked to the steering wheel through the magnetic field detected by the sensing unit.

The control module may include a motor, and the motor may be configured to provide a driving force to control a rotation angle of a wheel that is not linked to the steering wheel in response to the rotation angle of the wheel linked to the steering wheel.

The control module may include a circuit board electrically connecting the motor to the sensing unit.

The circuit board may be disposed at an end of the motor, a housing extending in a direction parallel to an axial direction of the steering shaft may be disposed on the circuit board, a side surface of the housing may be flat, and the sensing unit may be attached to a surface of the housing, which faces the steering shaft.

The steering wheel may be linked to a front wheel of a vehicle, may detect a change in magnetic field through the sensing unit as the steering wheel rotates to calculate a rotation angle of the front wheel, and the motor of the control module may rotate a rear wheel to correspond to a rotation amount of the front wheel.

A press-fit pin may protrude from the housing, a press-fit hole may be disposed in the sensing unit, and the sensing unit may be electrically connected to the circuit board in a manner in which the press-fit pin is inserted into the press-fit hole.

The sensing unit may be connected to the housing through heat fusing.

The steering device may include a cover part that covers the housing, the sensing unit, and the circuit board of the control module.

The magnet may be disposed to be exposed from the steering shaft, the cover part may extend toward the steering shaft to cover a part of the steering shaft on which the magnet is disposed, and the magnet and the sensing unit may directly face each other inside the cover part.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating a steering device according to one embodiment of the present invention;

FIG. 2 is a front cross-sectional view illustrating the steering device according to one embodiment of the present invention;

FIG. 3 is a side cross-sectional view illustrating the steering device according to one embodiment of the present invention;

FIG. 4 is a view illustrating a control module of the steering device according to one embodiment of the present invention;

FIG. 5 is a view illustrating a cover disposed on the control module of the steering device according to one embodiment of the present invention;

FIG. 6 is a view illustrating a steering device according to another embodiment of the present invention; and

FIG. 7 is a front cross-sectional view illustrating the steering device according to another embodiment of the present invention.

### DETAILED DESCRIPTION

Since the present invention may have various changes and various embodiments, specific embodiments are shown in the accompanying drawings and described in detail. However, it should be understood that it is not intended to limit specific embodiments and includes all modifications, equivalents, and substitutes included in the spirit and technical scope of the present invention. In describing the present invention, when it is determined that the detailed description of a related known technology may unnecessarily obscure the gist of the present invention, detailed description thereof will be omitted.

Terms such as first and second may be used to describe various components, but the components should not be limited by the terms. The terms are used only for the purpose of distinguishing one component from another.

Terms used in the present application are only used to describe specific embodiments and are not intended to limit the present invention. The singular includes the plural unless the context clearly dictates otherwise. In the application, it should be understood that terms such as “comprise” or “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

In addition, throughout the specification, when a certain component is described as being “connected” to another, this does not just mean that two or more components are directly connected and may mean that two or more components are indirectly connected through another component, are physically connected, and electrically connected, or are referred to as different names depending on positions or functions thereof but are integrated.

In addition, when a component is described as being formed or disposed on “on (above) or below (under)” another component, “on (above)” or “below (under)” may include not only a case in which two components are in direct contact with each other, but also a case in which one or more other components are formed or disposed between the two components. In addition, when described as “on (above) or below (under),” it may include the meaning of not only an upward direction but also a downward direction based on one component.

Hereinafter, a steering device according to embodiments of the present invention will be described in detail with reference to the accompanying drawings, and in describing the present invention with reference to the accompanying drawings, the same or corresponding components are denoted as the same reference numeral, and overlapping descriptions thereof will be omitted.

A rear wheel steering system is a system for controlling a rear wheel steering angle according to a steering angle of a front wheel. A rear wheel may be rotated in a direction corresponding to the steering angle of the front wheel to secure stability during high-speed driving and rotated in a direction opposite to the steering angle of the front wheel to secure a smaller rotation radius.

When the rear wheel is controlled in this way, rotation can be easier or driving stability can be secured when the vehicle travels. Since the rear wheel may be automatically controlled according to the angle of the front wheel, a device for detecting the steering angle of the front wheel needs to be provided.

Conventional steering devices may detect the steering angle of the front wheel in a manner in which a magnet is provided on steering shaft and a sensing unit disposed adjacent to the magnet detects a magnetic field, which varies depending on movement of a magnet. When the steering angle of the front wheel is detected, a separate motor may be installed to control a steering angle of a rear wheel in response thereto.

The sensing unit provided in the conventional steering device may be connected adjacent to the steering shaft, and a cable connecting the sensing unit to a circuit board provided on the motor may be disposed to operate the motor in response to the steering angle of the front wheel detected by the sensing unit.

However, since the sensing unit and the circuit board are connected via the cable, an additional space is required, and a connection part to which the cable is connected should be formed on the circuit board provided at one side of the motor.

The present invention provides a steering device in which a sensing unit 25 may be directly attached to a housing 24 connected to a circuit board 16, and a magnet 12 and the sensing unit 25 may be disposed to face each other at adjacent positions to easily detect a steering angle without a separate cable.

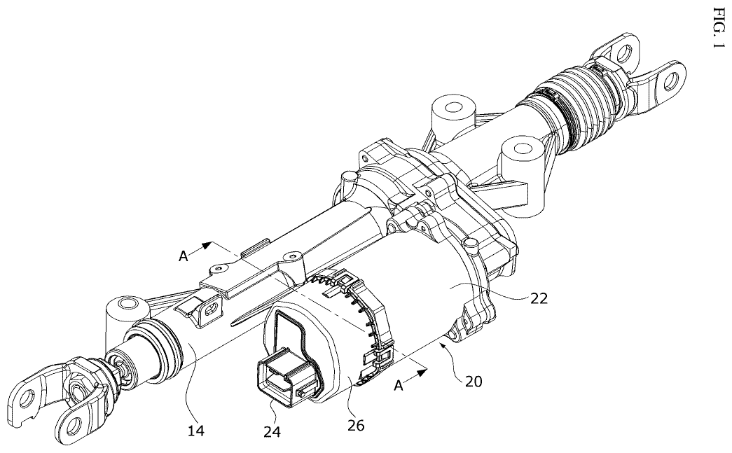

FIG. 1 is a view illustrating a steering device according to one embodiment of the present invention.

Referring to FIG. 1, a steering device according to one embodiment of the present invention may include a steering shaft 10 which moves in a longitudinal direction in conjunction with the rotation of a steering wheel, a magnet 12 attached to the steering shaft 10, and a control module 20 disposed adjacent to the steering shaft 10.

The control module 20 may be disposed parallel to the steering shaft 10, and the sensing unit 25 and the magnet 12 may be disposed to face each other on facing surfaces of the control module 20 and the steering shaft 10, respectively.

The sensing unit 25 provided on a side surface of the control module 20 is disposed on a surface of the control module 20, which faces the steering shaft 10, to minimize a gap with the magnet 12. The sensing unit 25 may detect a rotation angle of a wheel linked to a steering wheel through a detected magnetic field. The steering shaft 10 is covered by a steering shaft housing 14, and the steering shaft 10 is disposed to move in a longitudinal direction therein. The magnet 12 may be attached to the steering shaft 10, and the sensing unit 25 may detect a magnetic field of the magnet 12.

The control module 20 may include a motor 22 for controlling a wheel which is not linked to a steering wheel. When the sensing unit 25 detects a change in magnetism according to movement of the steering shaft 10 to detect a rotation angle of a front wheel, the motor 22 may rotate the rear wheel in a direction in which driving is facilitated, such as a direction corresponding to the front wheel.

A clamp-shaped fastening unit may be formed at both ends of the steering shaft 10, and the rear wheel may be connected to the fastening unit and rotated by driving the motor 22. The front wheel and the steering shaft 10 may be linked through a separate electric signal or the like so that the steering shaft 10 may move in the longitudinal direction as the front wheel rotates.

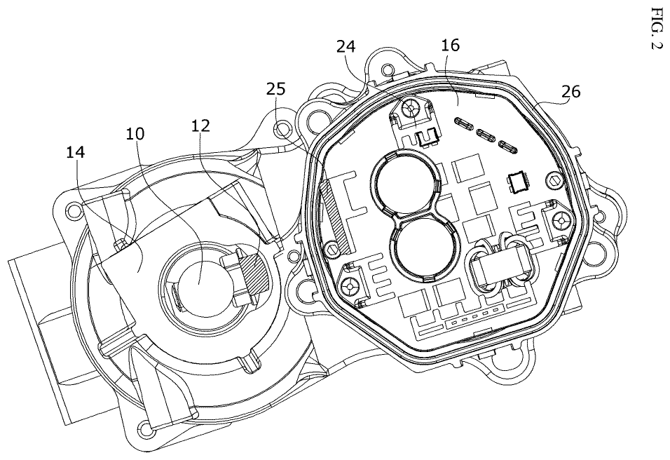

FIG. 2 is a front cross-sectional view illustrating the steering device according to one embodiment of the present invention.

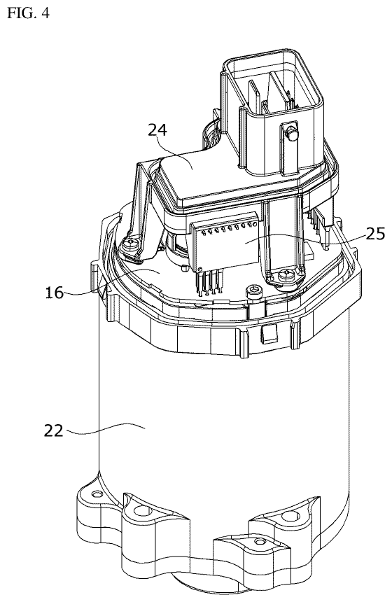

FIG. 2 corresponds to a view illustrating a cross-section along line A-A illustrated in FIG. 1. The control module 20 may include the motor 22, the circuit board 16 disposed at an end of the motor 22, and the housing 24 extending from the circuit board 16, which can be confirmed through FIG. 4. Accordingly, it can be confirmed that the housing 24 and the circuit board 16 are illustrated through a surface along line A-A. The circuit board 16 may serve to electrically connect the sensing unit 25 to the motor 22.

It can be seen that the sensing unit 25 illustrated in FIG. 2 is disposed to extend from a side surface of the housing 24 in the longitudinal direction of the steering shaft 10. That is, a cross section of the sensing unit 25 illustrated in FIG. 2 corresponds to a side cross section of the sensing unit 25.

It can be confirmed that the steering shaft 10 is disposed to be inserted into the steering shaft housing 14 and the magnet 12 is attached to the steering shaft 10. The magnet 12 protrudes in a direction in which the control module 20 is formed to face the sensing unit 25 and is attached. To provide the magnet 12, an empty space may be formed inside the steering shaft housing 14 so that the magnet 12 may be disposed.

The sensing unit 25 and the magnet 12 face each other and are disposed so that the housing 24 and the steering shaft housing 14 cover the empty space between the sensing unit 25 and the magnet 12. Materials of the housing 24 and the steering shaft housing 14 may be selected so that the sensing unit 25 may easily detect the magnetic field of the magnet 12. For example, the housing 24 and the steering shaft housing 14 may be formed of a plastic resin.

The housing 24 is attached to the circuit board 16, and the circuit board 16 is disposed on one end portion of the motor 22. Accordingly, the housing 24 may be disposed to protrude from the end portion of the motor 22. The housing 24 may extend from the circuit board 16 and may be formed so that the sensing unit 25 may be fixedly disposed to face the magnet 12. The housing 24 may serve as a support for the sensing unit 25 and include some elements to electrically connect the sensing unit 25 to the circuit board 16.

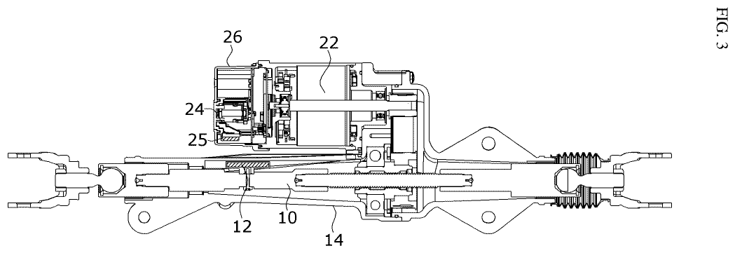

FIG. 3 is a side cross-sectional view illustrating the steering device according to one embodiment of the present invention.

Referring to FIG. 3, it can be confirmed that the magnet 12 is attached to one side of the steering shaft 10, which extends to be long, and the steering shaft 10 is covered by the steering shaft housing 14. The steering shaft housing 14 surrounds the steering shaft 10 and provides a free space to move the steering shaft 10 in the longitudinal direction. Since the magnet 12 is disposed at one side of the steering shaft 10 and the magnet 12 moves along with the steering shaft 10, a space in which the magnet 12 may move is provided inside the steering shaft housing 14.

The control module 20 may be disposed on a side surface of the steering shaft 10. The control module 20 may be disposed in a direction parallel to the steering shaft 10. The control module 20 may include the motor 22, the circuit board 16, the housing 24, and a cover part 26. The motor 22 may be linked to a wheel which is not linked to the steering wheel to rotate the wheel. For example, the motor 22 may be linked to the rear wheel, and the front wheel may be linked to the steering wheel.

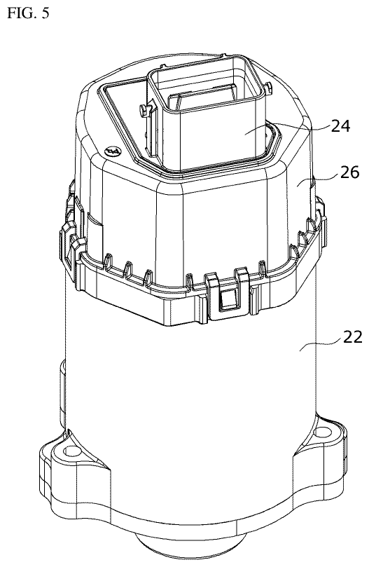

FIG. 4 is a view illustrating a control module of the steering device according to one embodiment of the present invention, and FIG. 5 is a view illustrating a cover disposed on the control module of the steering device according to one embodiment of the present invention.

Referring to FIGS. 4 and 5, the control module 20 according to one embodiment of the present invention may include the motor 22, the circuit board 16, the housing 24, and the cover part 26.

The circuit board 16 may be provided on one end portion of the motor 22 and may be electrically connected to the motor 22. The housing 24 may be disposed on the circuit board 16, and the housing 24 may be seated on and protrude from the end portion of the motor 22.

A side surface of the housing, which faces the steering shaft 10, may be formed to be flat. The sensing unit 25 may be disposed on the corresponding surface. The sensing unit 25 may be coupled to the flat surface and may face the magnet 12 of the steering shaft 10. The sensing unit 25 may be connected to the housing 24 through a separate fastening device. The fastening device may be a press-fit pin. A hole into which the press-fit pin may be inserted may be formed in the sensing unit 25, and the press-fit pin may be press-fitted into the hole so that the sensing unit 25 is coupled to the housing 24 and also electrically connected to the circuit board 16.

The sensing unit 25 may be connected to the circuit board 16 through the press-fit pin and have a separate fastening unit to be stably fixed to the housing 24. The sensing unit 25 may be connected and stably fixed to the housing 24 by a heat fusing method. In addition, any method capable of connecting the sensing unit 25 to the housing 24 may be applied.

Since the sensing unit 25 is directly connected to the housing 24, no separate cable fastening unit may be provided. Accordingly, the size and structure of the housing 24 may be designed to be small and simple.

Since the motor 22, the sensing unit 25, and the circuit board 16 are electrically connected components, it should be protected from an external impact and introduction of moisture. Accordingly, the control module 20 may include a cover part 26 for covering the housing 24 and the circuit board 16. The cover part 26 may cover the housing 24, the sensing unit 25, and the circuit board 16, thereby being protected from an external impact, dust, and introduction of moisture. The cover part 26 also covers a space between the sensing unit 25 and the magnet 12 and thus may be formed of a material which does not affect measurement of a magnetic field.

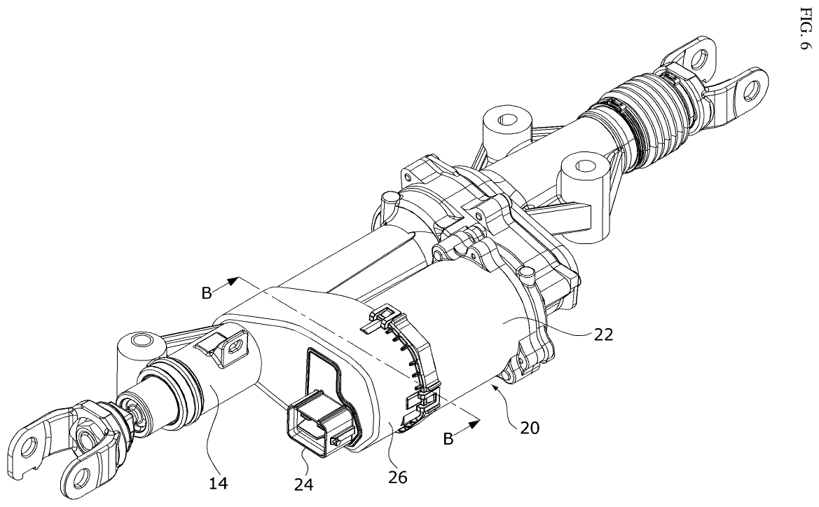

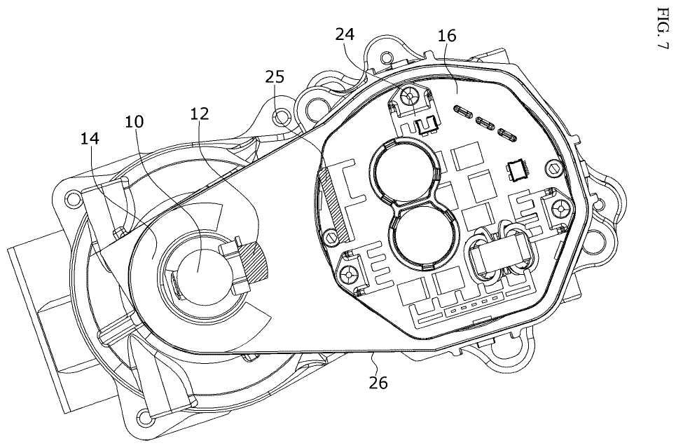

FIG. 6 is a view illustrating a steering device according to another embodiment of the present invention, and FIG. 7 is a front cross-sectional view illustrating the steering device according to another embodiment of the present invention.

Referring to FIGS. 6 and 7, the cover part 26 of the steering device according to another embodiment of the present invention covers the housing 24, the circuit board 16, and the sensing unit 25 of the control module 20 and may extend in a direction in which the steering shaft 10 is disposed to cover a part of the steering shaft 10.

As illustrated in FIG. 6, the cover part 26 may extend to cover at least a part of the steering shaft 10. Since the steering shaft 10 is provided with the magnet 12, the magnet 12 may be disposed on a portion covered by the cover part 26.

FIG. 7 is a cross-sectional view along line B-B in FIG. 6. Referring to a cross section, the magnet 12 provided at one side of the steering shaft 10 may be surrounded by the steering shaft housing 14, but unlike this, a part of the steering shaft housing 14 may be cut, and the magnet 12 may be exposed to the outside. A portion of the steering shaft housing 14, in which the magnet 12 is disposed, may be cut and open, and the magnet 12 may be disposed to be exposed from the steering shaft housing 14. The corresponding portion may be surrounded by the cover part 26, and the magnet 12 and the sensing unit 25 may be disposed inside the cover part 26.

Since the steering shaft housing 14 is cut and the cover part 26 extends to cover both the magnet 12 and the sensing unit 25, no separate component may be provided between the magnet 12 and the sensing unit 25. That is, the magnet 12 and the sensing unit 25 may be disposed to face each other directly without any obstacle therebetween.

An interior of the cover part 26 may be formed as an empty space so that the magnet 12 and the sensing unit 25 may face each other directly, and the sensing unit 25 may easily detect a change in magnetic field of the magnet 12. In this case, a separation distance between the sensing unit 25 and the magnet 12 may be adjusted by adjusting a shape of the housing 24 or the steering shaft 10.

At least a part of the housing 24 may protrude in a direction in which the steering shaft 10 is disposed. The sensing unit 25 may be disposed on the protruding portion of the housing 24 to reduce the distance between the sensing unit 25 and the magnet 12.

In contrast, a portion of the steering shaft 10, to which the magnet 12 is attached, may protrude. At least a part of the steering shaft 10 may protrude in a direction in which the housing 24 is disposed, and the magnet 12 may be disposed on the protruding portion to reduce the distance between the sensing unit 25 and the magnet 12.

According to one embodiment of the present invention, since a sensing unit provided in a control module is disposed to face a magnet provided on a steering shaft, it is possible to easily detect a rotation angle of a wheel linked to the steering shaft without a separate cable.

Various and beneficial advantages and effects of the present invention are not limited to the above-described contents and will be more readily understood in a process of describing specific embodiments of the present invention.

Although the above description has been made with reference to specific embodiments of the present invention, those skilled in the art will be able to understand that the present invention may be variously modified and changed without departing from the spirit and scope of the present invention described in the appended claims.

What is claimed is:

1. A steering device comprising:
a steering shaft configured to move in a longitudinal direction in conjunction with rotation of a steering wheel;
a magnet attached to the steering shaft;
a control module disposed adjacent to the steering shaft; and
a sensing unit disposed on a surface of the control module and configured to detect a magnetic field, wherein the control module is configured to detect a rotation angle of a wheel linked to the steering wheel through the magnetic field detected by the sensing unit.

2. The steering device of claim 1, wherein the control module includes a motor, and
the motor is configured to provide a driving force to control a rotation angle of a wheel that is not linked to the steering wheel in response to the rotation angle of the wheel linked to the steering wheel.

3. The steering device of claim 2, wherein the control module includes a circuit board electrically connecting the motor to the sensing unit.

4. The steering device of claim 3, wherein the circuit board is disposed at an end of the motor,
a housing extending in a direction parallel to an axial direction of the steering shaft is disposed on the circuit board,
a side surface of the housing is flat, and
the sensing unit is attached to a surface of the housing, which faces the steering shaft.

5. The steering device of claim 4, wherein the steering wheel is linked to a front wheel of a vehicle and detects a change in magnetic field through the sensing unit as the steering wheel rotates to calculate a rotation angle of the front wheel, and
the motor of the control module rotates a rear wheel to correspond to a rotation amount of the front wheel.

6. The steering device of claim 5, wherein a press-fit pin protrudes from the housing,
a press-fit hole is disposed in the sensing unit, and
the sensing unit is electrically connected to the circuit board in a manner in which the press-fit pin is inserted into the press-fit hole.

7. The steering device of claim 6, wherein the sensing unit is connected to the housing through heat fusing.

8. The steering device of claim 7, further comprising a cover part that covers the housing, the sensing unit, and the circuit board of the control module.

9. The steering device of claim 8, wherein the magnet is disposed to be exposed from the steering shaft,
the cover part extends toward the steering shaft to cover a part of the steering shaft on which the magnet is disposed, and
the magnet and the sensing unit directly face each other inside the cover part.
